(19) United States
(12) Patent Application Publication
(10) Pub. No.: US 2020/0191037 A1
(43) Pub. Date: Jun. 18, 2020

(54) METHOD FOR OPTIMIZING EXHAUST FLOW THROUGH AN EMISSIONS CONTROL SUBSTRATE TOWARDS AN EXHAUST SENSOR

(71) Applicant: DENSO International America, Inc., Southfield, MI (US)

(72) Inventors: Edward SZCZEPANSKI, Grosse Pointe Woods, MI (US); Nicholas POLCYN, Commerce, MI (US); Han-Yuan CHANG, Ann Arbor, MI (US)

(21) Appl. No.: 16/224,102

(22) Filed: Dec. 18, 2018

(51) Int. Cl. F01N 3/28; G06F 17/50; F01N 3/022

(52) U.S. Cl. CPC F01N 3/2803; G06F 17/5086; G06F 17/5009; F01N 2330/48; G06F 2217/08; F01N 2250/02; F01N 2330/34; F01N 3/0222

(57) ABSTRACT

A method for designing an emissions control substrate of an engine exhaust system to optimize exhaust flow through the emissions control substrate to an exhaust sensor within or proximate to the substrate. The emissions control substrate includes an inner core and an outer core surrounding the inner core. The inner core defines a plurality of inner channels and the outer core defines a plurality of outer channels. The plurality of inner channels are smaller than the outer channels, such that the inner core has a greater channel density than the outer core.

### FIELD

The present disclosure relates to methods for optimizing exhaust flow through an emissions control substrate towards an exhaust sensor.

### BACKGROUND

This section provides background information related to the present disclosure, which is not necessarily prior art.

Emissions control substrates are often used with engine exhaust systems to treat exhaust before it is released into the atmosphere. For example, a catalytic converter substrate is often used with automobile exhaust systems to catalyze a redox reaction, thereby converting CO into CO₂, and converting NOx into N₂ and O₂. A particulate filter substrate is often used to treat exhaust from an engine by filtering particulate matter out of the exhaust.

Engine exhaust systems often include one or more exhaust sensors, such as one or more air/fuel ratio sensors (or any other suitable type of sensor, such as O₂ sensors). The sensors are arranged at any suitable location, such as between two exhaust emissions control substrates, or within a substrate. While current exhaust systems provide adequate exhaust flow to the sensors, it would be desirable to increase the flow of exhaust to the sensors. Increasing exhaust flow to the sensors will increase sensor responsiveness to changes in the air/fuel mixture, which will advantageously allow an engine control module to make faster modifications to the engine fuel injection strategy so that the engine burns more or less fuel, thereby increasing engine efficiency and reducing emissions. The present disclosure advantageously includes methods for optimizing exhaust flow through an emissions control substrate to one or more exhaust sensors to increase the responsiveness of the sensors.

Further areas of applicability will become apparent from the description provided herein. The description and specific examples in this summary are intended for purposes of illustration only and are not intended to limit the scope of the present disclosure.

### SUMMARY

This section provides a general summary of the disclosure, and is not a comprehensive disclosure of its full scope or all of its features.

A method for designing an emissions control substrate of an engine exhaust system to optimize exhaust flow through the emissions control substrate to an exhaust sensor within or proximate to the substrate. The emissions control substrate includes an inner core and an outer core surrounding the inner core. The inner core defines a plurality of inner channels and the outer core defines a plurality of outer channels. The plurality of inner channels are smaller than the outer channels, such that the inner core has a greater channel density than the outer core.

### DRAWINGS

The drawings described herein are for illustrative purposes only of select embodiments and not all possible implementations, and are not intended to limit the scope of the present disclosure.

FIG. 1 illustrates components of an engine exhaust system in accordance with the present disclosure;

FIG. 2 illustrates components of another engine exhaust system in accordance with the present disclosure;

FIG. 3A is a cross-sectional view of an emissions control substrate in accordance with the present disclosure;

FIG. 3B is a perspective view of the emissions control substrate of FIG. 3A;

FIG. 4A illustrates a method in accordance with the present disclosure for designing an emissions control substrate that optimizes exhaust flow therethrough towards an exhaust sensor; and

FIG. 4B illustrates a continuation of the method of FIG. 4A.

Corresponding reference numerals indicate corresponding parts throughout the several views of the drawings.

### DETAILED DESCRIPTION

Example embodiments will now be described more fully with reference to the accompanying drawings.

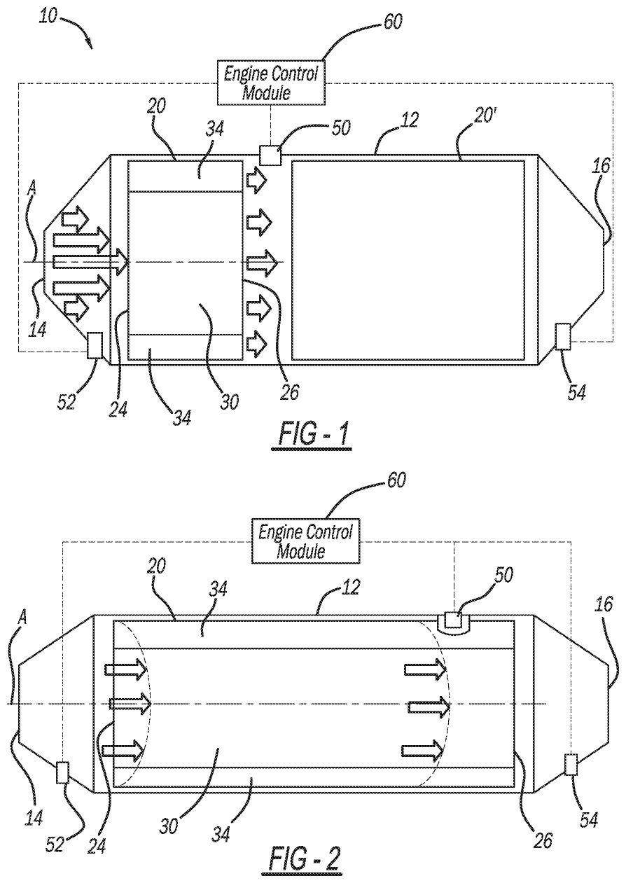

With initial reference to FIG. 1, an engine exhaust system according to the present disclosure is illustrated at reference numeral 10. The engine exhaust system 10 includes an exhaust chamber or shell 12 having an inlet 14 and an outlet 16 on opposite sides thereof. Exhaust enters the chamber 12 through the inlet 14, and exits the chamber 12 through the outlet 16.

Within the exhaust chamber 12 is at least one emissions control substrate 20, which can be configured as a catalytic converter and/or a particulate filter, for example, depending on the application. The emissions control substrate 20 receives exhaust from any suitable internal combustion engine, such as a vehicle engine, generator engine, etc. With respect to vehicles, the engine exhaust system 10 and the emissions control substrate 20 thereof can be included with any suitable vehicle such as passenger vehicles, sport utility vehicles, recreational vehicles, military vehicles, mass transit vehicles, locomotives, watercraft, aircraft, etc.

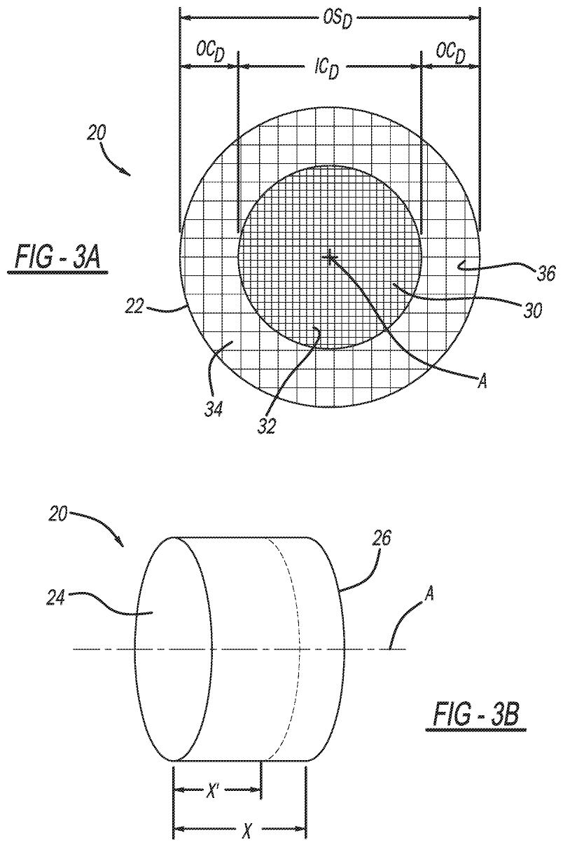

The substrate 20 can be an upstream emissions control substrate. As illustrated in FIG. 1, a downstream emissions control substrate 20′ may also be included. The downstream emissions control substrate 20′ is spaced apart from the substrate 20. The downstream substrate 20′ is downstream of the substrate 20 relative to exhaust flow through the chamber 12. With reference to FIG. 2, in some applications the chamber 12 may include only a single emissions control substrate 20.

The chamber 12 includes one or more exhaust sensors. Any suitable number of exhaust sensors may be included at any suitable location. The exhaust sensors may be any suitable type of exhaust sensor, such as one or more air/fuel ratio sensors, NOx sensors, ammonia sensors, particulate matter sensors, or O₂ sensors. In the example of FIG. 1, a mid-sensor 50 is arranged between the substrates 20 and 20′. Upstream of the substrate 20 is a pre-sensor 52, and downstream of the substrate 20′ is a post-sensor 54. In the example of FIG. 2, the mid-sensor 50 extends into the substrate 20.

The sensors 50, 52, and 54 are in communication with an engine control module 60. In this application, the term “module” may be replaced with the term “circuit.” The term “module” may refer to, be part of, or include processor hardware (shared, dedicated, or group) that executes code and memory hardware (shared, dedicated, or group) that stores code executed by the processor hardware. The code is configured to provide the features of the modules described herein. The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The engine control module 60 is configured to control an engine fuel injection strategy of the engine so that the engine burns an optimal amount of fuel based on operating conditions of the engine, thereby increasing engine efficiency and reducing emissions. The engine control module is in receipt of signals from each one of the sensors 50, 52, and 54 indicating, for example, the air/fuel mixture of the exhaust. As explained herein, the present disclosure advantageously provides for an optimized design of the emissions control substrate 20 that increases exhaust flow to the sensor 50 and reduces the amount of time needed for the exhaust to reach the sensor 50 as compared to existing substrates. As a result, the sensor 50 can detect changes in the air/fuel ratio more quickly, and the engine control module 60 can modify the operating conditions of the engine more quickly to increase fuel economy and reduce emissions.

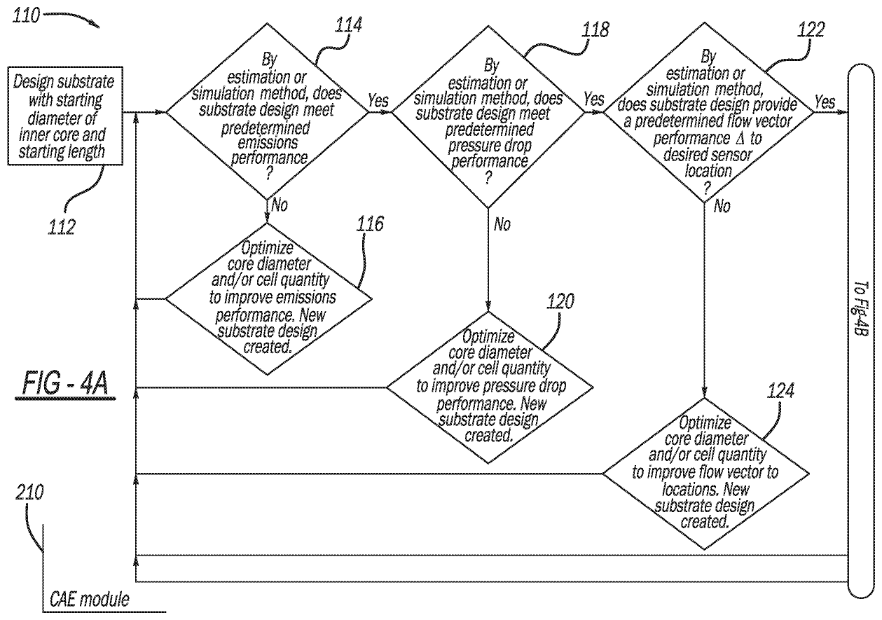

With additional reference to FIGS. 3A and 3B, the substrate 20 will be described in greater detail. The substrate 20 and the substrate 20′, can be formed in any suitable manner, such as with any suitable three-dimensional manufacturing or printing process (also known as additive manufacturing) using any suitable three-dimensional manufacturing device. Any suitable type of three-dimensional manufacturing can be used, such as, but not limited to, the following, which are generally referred to herein as three-dimensional printing: fused deposition modeling; fused filament fabrication; robocasting; stereo lithography; digital light processing; powder bed three-dimensional printing; inkjet head three-dimensional printing; electron-beam melting; selective laser melting; selective heat sintering; selective laser sintering; direct metal laser sintering; laminated object manufacturing; and electron beam freeform fabrication. The substrates 20 and 20′ can be manufactured apart from, or together with, the exhaust chamber 12. Three-dimensional printing may be used to manufacture the chamber 12 together with the substrate 20 (and optionally the substrate 20′), thereby simplifying manufacturing, assembly, and installation, and typically reducing the overall cost of the engine exhaust system 10.

The substrate 20 includes a body 22, which can be made of any suitable material, such as any suitable porous material. Any suitable ceramic porous material may be used, such as cordierite. The body 22 includes a first end (inlet end) 24 and a second end (outlet end) 26. Extending between the first end 24 and the second end 26 is an inner core 30 of inner exhaust channels 32, and an outer core 34 of outer exhaust channels 36. The channels 32/36 are defined by sidewalls of the body 22. The inner core 30 is at, and surrounds, a radial center of the body 22 through which the longitudinal axis A extends. The outer core 34 surrounds the inner core 30. The inner exhaust channels 32 and the outer exhaust channels 36 are arranged and configured to spread exhaust flow outward from the longitudinal axis A and the inner core 30 so that exhaust flow is less concentrated at the inner core 30. In the example illustrated, the inner exhaust channels 32 and the outer exhaust channels 36 extend parallel to a longitudinal axis A of the body 22. The channels 32 and 36 need not extend parallel to the longitudinal axis A, however, and thus may extend in any manner that is not parallel to the longitudinal axis A (e.g., a helical or wave-like manner, for example).

Depending on the application, the sidewalls may be coated with a wash coat, which can be applied in any suitable manner. When the emissions control substrate 20 is configured as a catalytic converter, the wash coat may include any suitable metallic catalyst configured to catalyze conversion of carbon monoxide, hydrocarbons, and nitrogen oxides to carbon dioxide, water vapor, and nitrogen gas. When the emissions control substrate 20 is configured as a particulate filter, such as a diesel particulate filter, the wash coat can include any metallic catalyst suitable to catalyze particulate filter regeneration. For example, the wash coat can include a precious metal including at least one of the following: platinum; palladium; rhodium; cerium; iron; manganese; nickel; and copper.

The channels 32 and 36 are arranged such that at the first end (inlet end) 24 of the body 22 some of the channels 32 and 36 define openings and are thus open to receive exhaust. Other ones of the channels 32 and 36 are closed at the first end 24 by first end (inlet end) plugs. The channels 32 and 36 that are open at the first end 24 are closed at the second end 26 by second end (outlet end) plugs. The channels 32 and 36 that are closed at the first end 24 by first end plugs are open at the second end 26, and thus define openings at the second end 26.

Exhaust flowing to the substrate 20 through the inlet 14 enters the body 22 through the openings at the first end 24. Due to the second end plugs, exhaust entering through the openings is forced through the sidewalls into adjacent channels 32,36 that define openings at the second end 26. The exhaust is treated as it flows through the sidewalls and through the wash coats. When the substrate 20 is configured as a particulate filter, particulate matter is filtered from the exhaust as the exhaust flows through the sidewalls. For example, when the substrate 20 is configured as a diesel particulate matter filter, the sidewalls can be made of any material that is suitable to filter (and thus trap therein) particulate matter. The particulate matter filter can be configured to filter any atmospheric pollutant including hydrocarbons or other chemicals, such as soot, ash, dust, fumes, smog, etc.

The wash coat can be any catalyst suitable for regenerating the substrate 20 by reducing the ignition temperature necessary to oxidize particulate matter that has accumulated on or in the sidewalls. Exemplary catalysts include, but are not limited to, platinum, palladium, rhodium, cerium, iron, manganese, nickel, and copper. When the substrate 20 is configured as a catalytic converter, the flow of exhaust from one channel 32/36 to another channel 32/26 facilitates interaction of exhaust with the wash coat to allow the catalyst of the wash coat to catalyze a redox reaction to treat toxic pollutants in the exhaust prior to release of the exhaust into the atmosphere. For example, the catalyst will convert carbon monoxide, hydrocarbon, and nitrogen oxides to carbon dioxide, water vapor, and nitrogen gas, for example.

With continued reference to FIGS. 3A and 3B, the inner core 30 has a starting inner core diameter IC_{D}. The outer core 34 has a starting outer core diameter OC_{D}. The substrate 20 has an overall substrate diameter of OS_{D}. The substrate has a starting depth or length X. The plurality of inner channels 32 each have diameters that are smaller than each one of the plurality of outer channels 36 such that the inner core 30 has a greater channel density than the outer core 34. The description of the substrate 20 may also apply to the substrate 20′, depending on the application. Thus in some applications the substrate 20′ may include the inner core 30 and the outer core 34. Alternatively, all of the exhaust channels of the substrate 20′ may have a uniform size. With respect to the substrate 20, it may include the inner core 30 and the outer core 34 as described above, or all of the exhaust channels of the substrate 20 may have a uniform size when the substrate 20′ includes the inner core 30 and the outer core 34. Thus, either one or both of the substrates 20 and 20′ may include the inner core 30 and the outer core 34 depending on the application. Also, in some applications the substrate 20 may be taller (extend further outward from the longitudinal axis A) and more shallow (have a reduced length or depth X), as compared to the substrate 20′. In some other applications, the substrate 20′ may be taller (extend further outward from the longitudinal axis A) and more shallow (have a reduced length or depth X), as compared to the substrate 20.

The starting diameter of the inner core IC_{D} is typically set such that exhaust pressure across the inner core 30 and the outer core 34 is uniform, such as at a cross-section taken across a mid-point of the substrate 20, or at the second end 26 (downstream face). For example, the following equation may be used to determine the starting diameter IC_{D} of the inner core 30:

$$γ = 1 - {\sum }_{i = 1}^{N} \frac{1}{2} \frac{\vert Vi - \overline{V} \vert}{\overline{V} S} Si$$

γ is velocity distribution through a cross-section of the substrate at a mid-point along a depth of the substrate. When γ=1, uniform exhaust flow across the cross-section is achieved. Vi is velocity of exhaust through the substrate. V is average velocity of exhaust through the substrate. Si is cross-sectional area of the starting diameter of the inner core. S is cross-sectional area of the substrate. i is one of the “n” cells in cross-section (i.e., i is n=1 (one individual) cell in the cross-section). U.S. Pat. No. 9,073,289 titled Honeycomb Structural Body (issued Jul. 7, 2015 and assigned to DENSO Corporation), which is incorporated herein in its entirety by reference, discloses an exemplary starting substrate 20 having a starting diameter of the inner core IC_{D}, and a starting length or depth X. The following paper also discloses use of the equation set forth above to design a substrate having a starting diameter of the inner core IC_{D}, and a starting length or depth X, and is incorporated herein by reference in its entirety: Yoshida, T., Suzuki, H., Aoki, Y., Hayashi, N. et al., “Development of a New Ceramic Substrate with Gas Flow Control Functionality,” SAE Int. J. Engines 10(4):1588-1594, 2017, https://doi.org/10.4271/2017-01-0919.

The starting diameter of the inner core IC_{D} is also based on exhaust concentration of at least one of total hydrocarbon emissions (THC), carbon monoxide CO, and (nitrogen oxides) NOx. When the substrate 20 is configured as a catalytic converter substrate, the starting diameter of the inner core IC_{D} may further be based on frequency factor and activation energy of the emissions control substrate 20.

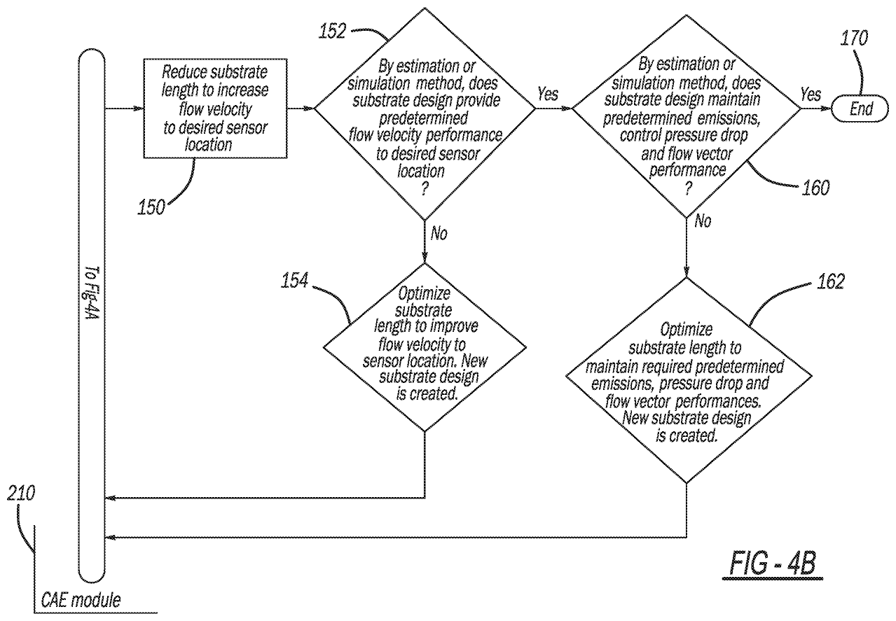

With reference to FIG. 4, a method for modifying the starting diameter of the inner core IC_{D} and the starting length or depth X of the substrate 20 in order to optimize exhaust flow through the emissions control substrate to the exhaust sensor 50 is illustrated at reference numeral 110. The method 110 advantageously modifies the size of the starting diameter of the inner core IC_{D} and reduces the depth X of the substrate 20 to increase exhaust flow volume and velocity to the exhaust sensor 50, thereby increasing the effectiveness and response time of the exhaust sensor 50. As a result, inputs from the sensor 50 to the engine control module 60 are more accurate and timely, thereby allowing the engine control module 60 to make faster modifications to the engine fuel injection strategy so that the engine burns more or less fuel, thereby increasing engine efficiency and reducing emissions.

The method 110 can be performed by any suitable processing device/system, such as any suitable computer aided engineering (CAE) module 210. An exemplary CAE module 210 includes Axisuite® by Exothermia SA of Thessaloniki, Greece. Axisuite® is a modular software for the simulation of exhaust after-treatment devices and systems. Axisuite® includes: axitrap (module for simulation of wall-flow particulate filters; supports uncoated filters with or without fuel-borne catalyst, or coated filters with any type of catalytic coating); axicat (module for simulation of flow-through catalytic converters with any kind of catalytic coating (DOC, TWC, SCR, LNT etc.) and a broad range of catalyst configurations (extruded, single-layer washcoat, dual-layer washcoat, zone-coated etc.)); axifoam (module for simulation of foam-based or fiber-based filters and catalysts, with any type of catalytic coating and a broad range of filter geometries); and axiheat (module for simulation of connecting pipes; models heat losses, fluid injection and evaporation, injection of gaseous mixtures, wall film modeling and chemical reactions in a broad range of pipe configurations (single-wall, airgap, insulated pipes etc.)).

The method 110 begins at block 112 with the emissions control substrate 20 including the inner core 30 having the starting diameter IC_{D}. At the starting diameter IC_{D}, the inner core 30 has a surface area that is similar to, or the same as, the outer core 34. The volume of the substrate 20 will be determined by original equipment manufacturers based on the volume of the engine combustion chamber or the overall engine volume displacement. Estimations using the volume of the substrate 20 will be used within software simulations against different cell densities and brick material thermal densities to determine if the volume of the substrate 20 with designated cell density and thermal density will sufficiently achieve emissions targets.

Further to the discussion above, the following gamma formula is used in the CAE module 210 to achieve a result as close to 1 as possible, such as 0.9 or higher:

$$γ = 1 - {\sum }_{i = 1}^{N} \frac{1}{2} \frac{\vert Vi - \overline{V} \vert}{\overline{V} S} Si .$$

This means that in the desired package space with a uniform cell density the OEM is satisfied that the substrate will receive the most exhaust exposure and will be distributed as uniformly as possible based on what the package space will allow. The developed substrate design 20′ cannot be valid if it reduces flow vector time to the sensor but degrades overall utilization of the substrate 20. As an industry standard the gamma of the substrate 20 would be expected to meet a gamma of 0.9. Therefore, the substrate 20′ with the introduction of the inner core 30 and the outer core 34 would need to pass a gamma of greater than or equal to 0.9 of the substrate 20, and show a time reduction in flow vectors spanning from a set distance inside the system to a sensor location for the method 110 to move from block 114 to block 118.

At block 114, the substrate 20 having the starting diameter IC_{D} of the inner core 30 is tested using any suitable estimation or CAE simulation method to determine if the substrate 20 meets predetermined emissions performance standards, such as those set by a government authority or an original equipment manufacturer (OEM). The following is an exemplary reaction rate formula, which may be used by the CAE module 210, to assess whether the substrate 20 meets or exceeds the predetermined emissions performance requirements: d[NO]=[(Sh·GSA)/D]·A·exp(−(E/RT))·([NO][CO]/S)·(dL/v). Wherein Sh=sherwood number; R=gas constant; GSA=geometric surface area; T=temperature; [C]=gas concentration; S=covering coefficient; A=frequency factor; dL=minute length of substrate; E=activation energies; v=flow velocity. The reaction/activation formula is used to estimate that there is enough surface area to both oxidize and reduce harmful emissions in various conditions and minimal thermal density to light-off as quickly as possible. The developed substrate design 20′ cannot be valid if it reduces flow vector time to the sensor, but degrades overall emissions conversion performance of the substrate 20. As an industry standard the substrate 20 is expected to meet a conversion efficiency for a number of exhaust gases in various conditions and qualify the emissions level of a vehicle and a safety margin. Therefore, the substrate 20′ having the inner core 30 and the outer core 34 would need to meet a conversion efficiency for a number of exhaust gases in various conditions and qualify the emissions level of a vehicle with a safety margin of greater than, or equal to, the substrate 20 and show a time reduction in flow vectors spanning from a set distance inside the system to a sensor location for the method 110 to proceed from block 114 to block 118.

If the predetermined emissions performance standards are not met, the method 110 proceeds to block 116. At block 116 the diameter IC_{D} of the inner core 30 is optimized (in some applications, the diameter IC_{D} of the inner core 30 and/or cell quantity of the substrate is optimized) to improve emissions performance so that the emissions performance meets or exceeds the predetermined emissions performance requirements. For example, the starting diameter IC_{D} of the inner core 30 may be increased (or the surface area thereof increased) to alter the pressure of exhaust flowing through the substrate 20. For example, increasing the starting diameter IC_{D} of the inner core 30 increases exhaust pressure at the second end 26 (downstream face) to direct more exhaust to the exhaust sensor 50. From block 116, the method 110 returns to block 114, where the new design of the substrate 20 with the increased IC_{D} of the inner core 30 is again tested by estimation or simulation to determine if the modified substrate 20 meets or exceeds the required emissions performance.

If at block 114 the CAE module 210 determines that the required emissions performance has been met or exceeded, the method 110 proceeds to block 118. At block 118, the CAE module determines whether the substrate 20 with the modified IC_{D} of the inner core 30 meets or exceeds required pressure drop performance. The CAE module 210 can determine whether the required pressure drop performance has been met or exceeded in any suitable manner, such as by way of the following equation of Hagen-Poiseuille's Law (which may be executed in any suitable manner, such as by hand or using any suitable CAE module 210): ΔP=(32×μ×L×Q)/(N×S×Dh²). Where S=n×(Dh/2)². Therefore ΔP=(128μ QL)/(πDh⁴); ΔP=pressure drop; L=substrate length; Q=gas flow rate; p=gas viscosity; N=number of cells; S=cell open area; Dh=hydraulic diameter. As an industry standard a substrate 20 or a system including the substrate 20 will be required to meet a pressure drop level of 10 kPa for a substrate 20 or 25 kPa for a substrate system. Therefore, the substrate 20′ must show a pressure drop of less than or equal to the substrate 20, or that of a system including substrate 20′ versus substrate 20, and show a time reduction in flow vectors spanning from a set distance inside the system to a sensor location for the method 110 to move from block 118 to block 122.

If the predetermined pressure drop performance is not met or exceeded, the method 110 proceeds to block 120. At block 120, the CAE module modifies the IC_{D} to improve pressure drop performance such that the pressure drop performance meets or exceeds the predetermined pressure drop performance requirement (in some applications, the diameter IC_{D} of the inner core 30 and/or cell quantity of the substrate 20′ is optimized). From block 120, the method 110 returns to block 114, where the CAE module tests whether the new design of the emissions control substrate 20 with the modified inner core diameter IC_{D} meets the predetermined emissions control requirements. If the required pressure drop performance has been met or exceeded, the method 110 proceeds to block 122.

At block 122, the CAE module 210 determines whether the modified design of the substrate 20 provides improved flow vector performance to the exhaust sensor 50. Study points are set within the system 10 including the substrates 20 and 20′, where flow vectors are evaluated based on a ratio of velocity=distance/time; where distance is constant as time is reduced, velocity of the vector increases. Time=distance/velocity can also be the method of evaluation where an increase in vector velocity equates to reduction in time as distance remains constant. In other words, substrate 20′ vector travel times to sensor location is less than or equal to substrate 20, or substrate 20′ vector velocity times to sensor location is greater than or equal to substrate 20 for the method 110 to move from block 122 to 150. Any suitable evaluation software may be used, such as STAR-CCM+ by Siemens.

If the modified inner core diameter IC_{D} design of the substrate 20 does not provide improved flow vector performance to the exhaust sensor 50, the method 110 proceeds to block 124. At block 124, the CAE module 210 modifies the inner core diameter IC_{D} of the inner core 30 to improve flow vector performance to the exhaust sensor 50 (in some applications, the diameter IC_{D} of the inner core 30 and/or cell quantity of the substrate 20′ is optimized). The diameter of the inner core 30 may be modified in any suitable manner, such as increased to add more pressure to the exhaust at the inner core 30, which will direct more exhaust outward from the longitudinal axis A towards the exhaust sensor 50.

From block 124, the method 110 returns to blocks 114, 118, and 122, where the CAE module 210 again checks the modified design of the inner core diameter IC_{D} of the inner core 30 to make sure that each one of the predetermined emissions performance requirements (see block 114), the pressure drop performance requirements (see block 118), and the flow vector performance requirements (see block 122) meet or exceed predetermine thresholds. If any one of the predetermined requirements at blocks 114, 118, and 122 are not satisfied, the method 110 again returns to blocks 116, 120, or 124 as illustrated in FIG. 4 to optimize the inner core diameter IC_{D} of the inner core 30 of the modified design of the substrate 20. After the predetermined emissions performance requirements, pressure drop performance requirements, and flow vector performance requirements have been met or exceeded, the method 110 proceeds to block 150.

Starting at block 150, the CAE module reduces the depth X of the modified design of the substrate 20 (such as to depth X′ as illustrated in FIG. 3B) to increase velocity of exhaust flow to the exhaust sensor 50. The CAE module reduces the depth X to the minimal depth at which the modified design of the substrate 20 satisfies the predetermined emissions control requirement, satisfies the predetermined pressure drop performance, satisfies the predetermined exhaust flow vector requirement to the exhaust gas sensor 50, and satisfies a predetermined exhaust flow velocity requirement to the exhaust sensor 50.

With reference to block 152, the CAE module 210 uses any suitable estimation or simulation to determine whether the reduced depth/length X of the modified design of the substrate 20 satisfies the predetermined exhaust flow velocity requirement to the exhaust gas sensor 50. If the predetermined exhaust flow velocity requirement is not satisfied, the method 110 proceeds to block 154. At block 154, the CAE module 210 modifies the depth/length X to improve the flow of velocity to the sensor 50. From block 154 the method 110 again cycles through blocks 114, 118, 122, 150, and 152. When at block 152 the CAE module 210 determines by any suitable estimation or simulation that the modified design of the substrate 20 satisfies the predetermined exhaust flow velocity requirement to the exhaust sensor 50, the method 110 proceeds to block 160.

At block 160, the CAE module 210 determines using any suitable estimation or simulation whether the modified design of the substrate 20 maintains the predetermined emissions performance requirements, satisfies the predetermined pressure drop performance, and satisfies the predetermined exhaust flow vector requirement to the exhaust sensor 50. If all of these predetermined requirements are satisfied, the method 110 proceeds to block 170. Otherwise, the method 110 proceeds to block 162, where the CAE module 210 reoptimizes the depth/length X. From block 162, the method 110 again cycles through blocks 114, 118, 122, 150, 152, and 160.

At block 170, the modified design of the emissions control substrate 20 is finalized. The finalized design of the modified emissions control substrate 20 (such as with an increased inner core diameter IC_{D} and a reduced depth/length X′) advantageously increases exhaust flow to the sensor 50, and improves response time of the sensor 50. The modified design of the substrate 20 can be manufactured in any suitable manner, such as by any suitable type of additive manufacturing as explained above, for example.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A method for designing an emissions control substrate of an engine exhaust system to optimize exhaust flow through the emissions control substrate to an exhaust sensor within or proximate to the substrate, the emissions control substrate including an inner core and an outer core surrounding the inner core, the inner core defining a plurality of inner channels and the outer core defining a plurality of outer channels, the plurality of inner channels are smaller than the outer channels such that the inner core has a greater channel density than the outer core:
determining whether the substrate satisfies, and modifying a diameter of the inner core until the substrate satisfies, at least one of the following: a predetermined emissions control requirement, a predetermined pressure drop performance, and a predetermined exhaust flow vector requirement to the exhaust sensor; and
reducing a depth of the substrate to a smallest depth at which the substrate satisfies the predetermined emissions control requirement, satisfies the predetermined pressure drop performance, satisfies the predetermined exhaust flow vector requirement to the exhaust sensor, and satisfies a predetermined exhaust flow velocity requirement to the exhaust sensor.

2. The method of claim 1, wherein the emissions control substrate is one of a catalytic converter substrate and a particulate filter substrate.

3. The method of claim 1, wherein modifying the diameter of the inner core includes modifying a starting diameter of the inner core, at the starting diameter of the inner core there is equalized gas flow distribution across a cross-section of the substrate.

4. The method of claim 3, further comprising using the following equation to determine the starting diameter of the inner core:
$$γ = 1 - {\sum }_{i = 1}^{N} \frac{1}{2} \frac{\vert Vi - \overline{V} \vert}{\overline{V} S} Si$$
wherein:
γ is velocity distribution through a cross-section of the substrate at a mid-point along a depth of the substrate, when γ=1 uniform exhaust flow across the cross-section is achieved;
Vi is velocity of exhaust through the substrate;
V is average velocity of exhaust through the substrate;
Si is cross-sectional area of the starting diameter of the inner core;
S is cross-sectional area of the substrate; and
i is one of the “n” cells in cross-section.

5. The method of claim 3, further comprising determining the starting diameter of the inner core based on exhaust concentration of at least one of total hydrocarbon emissions (THC), CO, and NOx.

6. The method of claim 1, wherein the inner core and the outer core both have a starting surface area that is at least substantially similar prior to the diameter of the inner core being modified.

7. The method of claim 1, wherein modifying the diameter of the inner core includes increasing the diameter.

8. The method of claim 1, wherein the emissions control substrate is a first substrate that is upstream of a second emissions control substrate of the engine exhaust system.

9. The method of claim 1, wherein the emissions control substrate is a first substrate that is downstream of a second emissions control substrate of the engine exhaust system.

10. A method for designing an emissions control substrate of an engine exhaust system to optimize exhaust flow through the emissions control substrate to an exhaust sensor within or proximate to the substrate, the emissions control substrate including an inner core and an outer core surrounding the inner core, the inner core defining a plurality of inner channels and the outer core defining a plurality of outer channels, the plurality of inner channels are smaller than the outer channels such that the inner core has a greater channel density than the outer core:
determining whether the substrate satisfies a predetermined emissions control requirement;
when the substrate does not satisfy the predetermined emissions control requirement, modifying a diameter of the inner core until the substrate satisfies the predetermined emissions control requirement;
determining whether the substrate satisfies a predetermined pressure drop performance;
when the substrate does not satisfy the predetermined pressure drop performance, modifying the diameter of the inner core until the substrate satisfies the predetermined pressure drop performance;
determining whether the substrate satisfies a predetermined exhaust flow vector requirement to the exhaust sensor;
when the substrate does not satisfy the predetermined exhaust flow vector requirement to the exhaust sensor, modifying the diameter of the inner core until the substrate satisfies the predetermined exhaust flow vector requirement; and
reducing a depth of the substrate to a smallest depth at which the substrate satisfies the predetermined emissions control requirement, satisfies the predetermined pressure drop performance, satisfies the predetermined exhaust flow vector requirement to the exhaust sensor, and satisfies a predetermined exhaust flow velocity requirement to the exhaust sensor.

11. The method of claim 10, wherein the emissions control substrate is one of a catalytic converter substrate and a particulate filter substrate.

12. The method of claim 10, wherein modifying the diameter of the inner core includes modifying a starting diameter of the inner core, at the starting diameter of the inner core there is equalized gas flow distribution across a cross-section of the substrate.

13. The method of claim 12, further comprising using the following equation to determine the starting diameter of the inner core:
$$γ = 1 - {\sum }_{i = 1}^{N} \frac{1}{2} \frac{\vert Vi - \overline{V} \vert}{\overline{V} S} Si$$
wherein:
γ is velocity distribution through a cross-section of the substrate at a mid-point along a depth of the substrate, when γ=1 uniform exhaust flow across the cross-section is achieved′
Vi is velocity of exhaust through the substrate;
V is average velocity of exhaust through the substrate;
Si is cross-sectional area of the starting diameter of the inner core;
S is cross-sectional area of the substrate; and
i is one of the “n” cells in cross-section.

14. The method of claim 12, further comprising determining the starting diameter of the inner core based on exhaust concentration of at least one of total hydrocarbon emissions (THC), CO, and NOx.

15. The method of claim 14, further comprising determining the starting diameter of the inner core based on shape and size of the emissions control substrate.

16. The method of claim 14, further comprising determining the starting diameter of the inner core based on frequency factor and activation energy of the emissions control substrate.

17. The method of claim 10, wherein the inner core and the outer core both have a starting surface area that is at least substantially similar prior to the diameter of the inner core being modified.

18. The method of claim 10, wherein modifying the diameter of the inner core includes increasing the diameter.

19. The method of claim 10, wherein the emissions control substrate is a first substrate that is upstream of a second emissions control substrate of the engine exhaust system.

20. The method of claim 10, wherein the emissions control substrate is a first substrate that is downstream of a second emissions control substrate of the engine exhaust system.
